(19) United States
(12) Patent Application Publication
(10) Pub. No.: US 2012/0302651 A1
(43) Pub. Date: Nov. 29, 2012

(54) Flame Retardant Additive Composition and Polyurethane Foam-Forming Composition and Polyurethane Foam Containing Same

(76) Inventor: Jeffrey Stowell, Wingdale, NY (US)

(21) Appl. No.: 13/391,981

(22) PCT Filed: Aug. 25, 2010
(86) PCT No.: PCT/US10/46638

§ 371 Date: Apr. 16, 2012

Related U.S. Application Data
(60) Provisional application No. 61/239,837, filed on Sep. 4, 2009.

(51) Int. Cl. C09K 21/12; C08L 75/04; C08J 9/00

(52) U.S. Cl. 521/108; 521/170; 252/609

(57) ABSTRACT

There is provided herein a flame-retardant additive composition comprising a halogenated hydroxyl-containing compound; and, a dialkyl phosphite. There is also provided polyurethane foam-forming composition(s) containing the flame-retardant additive, and polyurethane foams made therefrom.

### FIELD OF THE INVENTION

The present invention is directed towards flame retardant additive compositions and polyurethane foam compositions containing the same. More particularly, the present invention is directed towards stabilized, low scorch flame retardant additives for polyurethane foam.

### BACKGROUND OF THE INVENTION

Scorch can be a problem in polyurethane foam in that scorch causes undesirable levels of discoloration in the polyurethane foam product.

This discoloration is especially apparent within the center of foam blocks where the internal temperatures remain high for a relatively long period of time. The exposure of the interior of the foams to high temperatures may lead to embrittlement and core discoloration commonly known as scorching. In some severe cases, scorching can cause a degradation of physical properties. The use of flame retardants can lead to even higher discoloration in polyurethane foams when compared to non-flame retardant foam grades.

In many cases flame retardant additives known to aggravate foam scorch contain stabilizer components to minimize their contribution to foam discoloration. Although not often studied, there are many situations in which the stabilizing components added to the flame retardants react with each other and/or the flame retardant itself leading to a fast or in some cases prolonged deterioration of the scorch minimizing properties of the stabilizer additives. Such side-reactions/incompatibilities can consume a portion or all of the stabilizer components therein and lower the effectiveness of the stabilizer additives over time, resulting in an increase in the level of scorch in polyurethane foam made therefrom.

There exists a need in the field of polyurethane foam for flame retardants that have decreased scorch properties; and for those flame retardants that typically produce higher levels of scorch, a need for scorch-reducing stabilizers that are effective as well as storage stable when added to those flame retardant products.

### SUMMARY OF THE INVENTION

It has been surprisingly found that the use of a dialkyl phosphite ester with a halogenated hydroxyl-containing compound, e.g., tribromoneopentyl alcohol, does not result in the undesirable side-reaction often observed when the alcohol is combined with triester phosphites, e.g., transesterification of the phosphite by the halogenated hydroxyl-containing compound over time, which thus, results in dramatically improved storage stability and scorch performance.

There is provided in one embodiment herein, a flame-retardant additive composition consisting essentially of (a) a halogenated hydroxyl-containing compound; and, (b) a dialkyl phosphite.

There is provided in another embodiment herein, a polyurethane foam-forming composition comprising (i) a polyol, (ii) an isocyanate, (iii) a blowing agent and (iv) a flame retardant additive composition comprising (a) a halogenated hydroxyl-containing compound; and, (b) a dialkyl phosphite

There is provided in yet another embodiment herein, a flame retardant additive composition comprising

(a) a halogenated hydroxyl-containing compound;

(b) a phosphorus(V) ester; and,

(c) a dialkyl phosphite.

There is also provided in yet even another embodiment herein, a method of making polyurethane foam comprising:

combining a polyol, an isocyanate, a blowing agent, and a flame retardant additive composition comprising

(a) a halogenated hydroxyl-containing compound; and,

(b) a dialkyl phosphite.

### DETAILED DESCRIPTION OF THE INVENTION

It will be understood herein that all ranges can comprise any combination of endpoints of any of the recited ranges and any subranges therebetween.

The present invention is directed towards the use of a dialkyl phosphite ester with halogenated hydroxyl-containing compound, e.g., tribromoneopentyl alcohol, as flame retardant additive components, specifically as flame retardant additive components for polyurethane foam. Since dialkyl phosphite esters are reactive with isocyanates, typically high in acidity, and significantly more expensive than the commonly used triester phosphites, applicants have unexpectedly discovered that the use of dialkyl phosphite esters can function effectively as flame retardant stabilizer components, while avoiding undesirable transesterification with a halogenated hydroxyl-containing flame retardant compound, which has been shown to occur in the presence of the commonly used triester phosphite stabilizers.

The halogenated hydroxyl-containing compound preferably, contains more than one halogen moiety, more preferably, more than two halogen moieties. Some non-limiting examples of halogen moieties comprise bromide and chloride moieties. In one embodiment herein, the halogenated hydroxyl-containing compound is a brominated compound. More preferably, the halogenated hydroxyl-containing compound is an aliphatic brominated hydroxyl-containing compound.

In one embodiment, the halogenated hydroxyl-containing compound can be solvated, preferably in a phosphorus(V) ester, more preferably an aryl phosphate ester such as a butylated triphenyl phosphate ester, isopropylated triphenyl phosphate ester, alkyl/aryl phosphate ester (e.g., 2-ethylhexyl diphenyl phosphate, isodecyl diphenyl phosphate), cresyl diphenyl phosphate, dibutyl phenyl phosphate, butyl diphenyl phosphate, resorcinol bis(diphenyl phosphate), bisphenol A bis(diphenyl phosphate) and combinations thereof. Some non-limiting examples of phosphorous (V) ester which are not aryl phosphate esters which can be used as the phosphorous (V) ester can be triethyl phosphate, diethyl ethylphosphonate, tris(2-butoxyethyl) phosphate, tris(2-chloropropyl) phosphate, tris(1,3-dichloroisopropyl) phosphate, diethyl-N,N-bis(hydroxyethyl)aminomethylphosphonate, oligomeric alkyl phosphate and/or phosphonate esters and combinations thereof. The phosphorous (V) ester can comprise combinations of any of the aforesaid aryl phosphate esters, alkyl/aryl phosphate esters and non-aryl phosphate esters. The amount of solvating phosphorous (V) ester can vary greatly depending on the other parameters and components of the flame retardant additive composition. Generally the amount of solvating phosphorous (V) ester can be from about 10 to about 90, more preferably from about 30 to about 85 and most preferably from about 50 to about 80.

The halogenated hydroxyl-containing compound can also be a halogenated polyether or polyester polyol, such as the non-limiting example of a brominated polyol. In one embodiment herein the halogenated polyol is any of the polyols described herein provided said polyol contains at least one hydroxyl moiety. In one non-limiting embodiment the halogenated hydroxyl-containing compound can contain only one hydroxyl moiety.

Preferably, the halogenated hydroxyl-containing compound is selected from the group consisting of tribromoneopentyl alcohol, dibromoneopentyl glycol, brominated polyether polyols such as the non-limiting examples of Ixol M125, Ixol B251, (both of these tradenamed products being chemically described in the Toxic Substances Control Act (TSCA) by the general CAS# 68441-62-3 (the contents of which are incorporated herein in their entirety (a 2-butyne-1,4-diol, polymer with (chloromethyl)oxirane, which polymer is brominated, dehydrochlorinated, and methoxylated)) and combinations thereof.

The dialkyl phosphite used herein can be of the general formula (I):

P(═O)(OR)₂H (I)

wherein R is an alkyl group each containing from 1 to about 20 carbon atoms, preferably from 1 to about 18 carbon atoms, more preferably from about 1 to about 16 carbon atoms and most preferably from about 1 to about 12 carbon atoms, or where the two R groups are attached to each other to form a ring structure with the phosphorous atom. In one other embodiment, the lower endpoint of the above ranges of carbon atoms present in R can be any one of 2, 4, or 6. It will be understood that the aforementioned alkyl groups can be linear or branched.

It will be understood herein that the use of the expression “dialkyl phosphite” can also encompass cyclic hydrogen phosphites wherein the two R alkyl groups are covalently bound to each other to form a cyclic structure with the phosphorous atom. The two R alkyl groups which are bound to each other to form the cyclic structure with the phosphorous atom can be linear or branched alkyl groups which are bound to each other at any point to form said cyclic hydrogen phosphite structure which is understood to be encompassed by the expression “dialkyl phosphite” herein.

Preferably the dialkyl phosphite is selected from the group consisting of bis(2-ethylhexyl) phosphite, dioleyl phosphite, dibenzyl phosphite, dimethyl phosphite, diethyl phosphite, di-n-propyl phosphite, diisopropyl phosphite, di-n-butylphosphite, di-isobutyl phosphite, di-sec-butyl phosphite, di-t-butyl phosphite, di-n-pentyl phosphite, 1,3-propanediol cyclic hydrogen phosphite, 2-methyl-1,3,-propanediol cyclic hydrogen phosphite, 2-2-dimethyl-1,3-propanediol cyclic hydrogen phosphite, and the like, and combinations thereof.

The amount of dialkyl phosphite than can be present in the flame retardant additive composition can vary greatly depending on the desired parameters and components of the polyurethane foam forming composition and the particular application for which foam made therefrom is intended. Generally the amount of dialkyl phosphite can comprise from about 0.1 to about 10, preferably from about 1 to about 7 and most preferably from about 2 to about 5 weight percent based on the total weight of the flame retardant additive composition.

As described above, a polyurethane foam-forming composition herein in addition to the flame retardant additive composition, can comprise a polyol, an isocyanate, a blowing agent, and optionally a polyurethane foam-forming catalyst, optionally a silicone surfactant and optionally, any other conventional additives.

The amount of flame retardant additive composition that can be present in the polyurethane foam-forming composition can vary greatly depending on the parameters and other components of the polyurethane foam-forming composition and can be determined by those skilled in the art. Generally, the amount of flame retardant additive composition that can be present in a polyurethane foam-forming composition can be from about 1 to about 15, preferably from about 2 to about 12 and most preferably from about 4 to about 10 weight percent based on the total weight of the polyurethane foam-forming composition.

Examples of polyols which can be used include those commonly used in the production of flexible polyurethane foams such as polyether polyols, polyester polyols and other polymer polyols.

Examples of polyether polyols include those with a hydroxyl value of from 25 to 70 mg KOH/g which are obtained by the random or block addition of alkylene oxides such as ethylene oxide and propylene oxide to polyfunctional polyols, amine compounds, and the like. Examples of polyfunctional polyols include glycols such as ethylene glycol and propylene glycol; triols such as glycerol and trimethylolpropane; polyols such as pentaerythritol, sorbitol and sucrose. Examples of amine compounds include ammonia, triethanolamine, ethylene diamine, diethylene triamine, aminoethyl piperazine and aniline.

Polyester polyols are compounds having terminal hydroxyl groups obtained by the polycondensation of polyfunctional carboxylic acids and polyfunctional hydroxyl compounds or the ring-opening self-condensation polymerizations of a lactone. The polyester polyols preferably have a number average molecular weight of from 500 to 10,000, and more preferably from 1000 to 5000. Examples of polyfunctional carboxylic acids include adipic acid, phthalic acid, succinic acid, azelaic acid and sebacic acid. Examples of polyfunctional hydroxy compounds include glycols such as ethylene glycol, propylene glycol, butanediol and diethylene glycol, and polyhydric alcohols such as glycerol, trimethylol propane and pentaerythritol. Examples of lactones include gamma-butyrolactone and epsilon-caprolactone.

Polymer polyols can be obtained by mixing a polyether polyol and an ethylenically unsaturated monomer, and, when necessary, adding chain transfer agents, dispersion stabilizers, and the like, to bring about the radical polymerization of the ethylenically unsaturated monomer in the presence of a radical initiator. Examples of ethylenically unsaturated monomers include monomers containing the cyano group such as acrylonitrile and methacrylonitrile; (meth)acrylic esters such as methyl (meth)acrylate, butyl (meth)acrylate, stearyl (meth)acrylate, hydroxyethyl (meth)acrylate, dimethylaminoethyl (meth)acrylate and dimethylaminopropyl (meth)acrylate; monomers containing carboxyl group such as acrylic acid, methacrylic acid, itaconic acid, maleic acid and fumaric acid; acid anhydride monomers such as maleic anhydride and itaconic anhydride; hydrocarbon compounds such as butadiene, isoprene and 1,4-pentadiene; aromatic hydrocarbon compounds such as styrene, alpha-methyl styrene, phenylstyrene and chlorostyrene; halogen-containing monomers such as vinyl chloride and vinylidene chloride; vinyl ethers such as vinyl ethyl ether and vinyl butyl ether; vinyl ketones such as vinyl ethyl ketone; vinyl esters such as vinyl acetate; acrylamides such as acrylamide, N,N-dimethylacrylamide, N-isopropylamide, N,N-dimethylaminopropyl acrylamide and methylene bisacrylamide; and methacrylamides such as N,N-dimethyl methacrylamide. Such ethylenically unsaturated monomers can be used alone or in combinations of two or more.

The aforementioned polyol components can be used alone or in combinations of two or more depending on the properties required of the flexible polyurethane foam that is to be prepared.

For example, a flexible polyurethane foam with high elasticity can be obtained when the aforementioned polyether polyol and polymer polyol are used in a proportion, based on the combined weight of the two, of from 30 to 90 weight percent of the former and from 70 to 10 weight percent of the latter, and preferably from 40 to 80 weight percent of the former and from 60 to 20 weight percent of the latter.

In one embodiment herein, the polyol is present in an amount of from about 80 to 120 parts, preferably from about 90 to about 110 parts, based on the total parts present in the composition. Generally a polyurethane foam-forming composition herein contains total parts of from about 150-250 parts, preferably from about 180 to about 220 parts, most preferably from about 190 to about 200 parts based on the total amount of parts in the composition. Most preferably, the amount of polyol is about 100 parts and such amount is used as the basis for the other components of the composition (parts per 100 parts polyol used=php).

In one other embodiment herein the halogenated hydroxyl-containing compound is generally present in an amount of from about 1 to about 20 php, more preferably from about 2 to about 18 php, and most preferably from about 2 to about 15 php, based on each 100 parts polyol used.

Examples of isocyanates which can be used include those having two or more isocyanate groups which have heretofore been used for making flexible polyurethane foams. Examples of such isocyanate compounds include aromatic isocyanates, aliphatic isocyanates and alicyclic isocyanates, as well as mixtures of two or more of such isocyanates, and modified isocyanates obtained by the modification of such isocyanates. Specific examples of such isocyanates are tolylene diisocyanate, diphenylmethane diisocyanate, polymethylene polyphenylene polyisocyanate (crude MDI), xylylene diisocyanate, isophorone diisocyanate and hexamethylene diisocyanate; and modified products of such polyisocyanates, such as carbodiimide-modified products, biuret-modified products, dimers and trimers. Prepolymers with terminal isocyanate groups obtained from such isocyanates and active hydrogen-containing compounds can also be used.

In one embodiment, the isocyanate index range can be from about 130 to about 80, more preferably, from about 120 to about 90 and most preferably from about 115 to about 95.

As the blowing agent in the flexible polyurethane foam-forming composition of the present invention, known blowing agents heretofore used in such compositions are suitably selected according to the properties required of the foamed product.

Water is a typical example of such a blowing agent; other examples include methylene chloride, n-butane, isobutane, n-pentane, isopentane, dimethyl ether, acetone, carbon dioxide, and the like. Depending on the desired density and other properties of the foamed polyurethane, these and other blowing agents can be used alone or in combinations of two or more in a manner known in the art.

The amount of blowing agent to be used is not particularly limited but will ordinarily range from 0.1 to 20 parts by weight per 100 parts by weight of the polyol component of the foam-forming composition. Preferably, the amount of blowing agent(s) will be such as to provide a foam density of from 0.8 to 2.5 pounds per cubic foot, and preferably from 0.9 to 2.0 pounds per cubic foot.

The polyurethane foam-forming composition herein can preferably contain any of the catalysts, and combination of catalysts, heretofore known or used for the production of polyurethane foams. Examples of useful catalysts include sodium hydroxide, sodium acetate, tertiary amines or materials which generate tertiary amines such as trimethylamine, triethylene diamine, N-methyl morpholine, N,N-dimethyl cyclohexylamine, and N,N-dimethyl aminoethanol. Also applicable are metal compounds such as hydrocarbon tin alkyl carboxylates, dibutyl tin diacetate, dibutyl tin dioctoate dibutyl tin dilaurate and stannous octoate; as well as other compounds intended to promote trimerization of the polyisocyanate such as, 2,4,6-tris(N,N-dimethylamino-methyl)phenol, 1,3,5-tris(N,N-dimethyl-3-aminopropyl)-S-hexahydrotriazine, potassium octoate, potassium acetate and catalysts such as DABCO TMR® and POLYCAT 43®.

Many other kinds of catalysts can be substituted for those listed above, if desired. The amount of catalyst used can advantageously range from 0.05 to 5 weight percent or more based on the total weight of polyol in the foam-forming mixture.

In one embodiment herein, the dialkyl phosphite does not substantially react with the isocyanate and/or polyol components in the polyurethane foam-forming composition. In another embodiment, while there may be some reaction of the dialkylphosphite with the isocyanate, it is a reversible reaction at foam-making temperatures, e.g., above 160-180° C., in the center of the foam bun, but a portion of the dialkyl phosphite that may react with the isocyanate can be reformed and thus, works to prevent foam scorch as is intended herein.

In another embodiment herein the polyol is a non-phosphorous containing polyol.

In one embodiment the polyol in the polyurethane foam forming composition is other than a halogenated hydroxyl-containing compound.

There is provided herein in one embodiment a polyurethane foam made by reacting the polyurethane foam-forming composition(s) described herein. Methods of reacting polyurethane foam forming composition are well known to those skilled in the art and will not be described herein in detail.

The use of a dialkyl phosphite in the flame retardant additive composition(s), and thus, the presence of dialkyl phosphite in polyurethane foam-forming compositions containing the same, which are described herein, results in no undesirable transesterification reaction (side-reaction) with halogenated hydroxyl-containing compound, as compared to a significant level of side reaction that would be the case with the use of an equivalent flame retardant additive composition, and the polyurethane foam-forming compositions containing the same, which contained a triester phosphite instead of a dialkylphosphite, over an extended storage period, e.g. greater than one month, preferably greater than 3 months, more preferably greater than 6 months and most preferably greater than 2 years. As described above, the side reaction which occurs with a triester phosphite results in less phosphite being available as an effective stabilizer, and as such, polyurethane foams made from polyurethane foam forming compositions containing triester phosphite and its side reaction products have an increased level of scorch as the flame retardant additive composition containing other than dialkyl phosphite is allowed to age for the periods recited herein.

The flame retardant additive composition herein which employs a dialkyl phosphite (whether such is equivalently aged (or is unaged) as long as the composition containing other than dialkyl phosphite) can be used in making a polyurethane foam which has a level of scorch that is lower than an equivalent polyurethane foam containing an equivalent flame retardant additive composition containing other than dialkyl phosphite, wherein other than dialkyl phosphite can be e.g., any triester phosphite (e.g., a trialkyl phosphite), that has been stored and allowed to transesterify with the hydroxyl-containing flame retardant for an extended period of time as described herein, e.g., greater than one month, preferably at least 6 months, and most preferably greater than 1 year; such level of scorch which is lower can comprise the ranges of delta E values described below. That is, the amount of scorch in a polyurethane foam containing the flame retardant additive composition of the invention herein is at least 3 units of delta E less, preferably at least 5 units of delta E less and most preferably at least 8 units of delta E less than that in an equivalent polyurethane foam containing a flame retardant additive composition that contains other than dialkylphosphite, wherein the flame retardant additive composition containing other than dialkyl phosphite has been aged at least 1 month (and any of the other aging period described herein). Additionally, such amount of scorch in a polyurethane foam containing the flame retardant additive composition of the invention herein can be at least any of 10, 12, 15, 18, 20, 25, and 30 or 40 units of delta E less than that in an equivalent polyurethane foam containing a flame retardant additive composition that contains other than dialkylphosphite, wherein the flame retardant additive composition containing other than dialkyl phosphite has been aged at least 1 month (and any of the other aging period described herein).

In addition, by using a dialkyl phosphite there is generally a low to no expected increase in values of scorch (e.g., delta E as defined below) in resultant polyurethane foams as the flame retardant additive sample ages for the periods recited herein, versus an equivalent polyurethane foam containing an equivalent unaged flame retardant additive composition.

Unaged is understood to mean a flame retardant additive composition (e.g. a composition containing other than a dialkyl phosphite) that has not been stored for a sufficient period of time to allow for transesterification as described herein, e.g., less than 6 months, preferably less than 3 months, more preferably less than 1 month, even more preferably less than 1 week, and most preferably a flame retardant additive composition that is formed and immediately used in a polyurethane foam-forming composition.

Aged is understood herein to mean a period of time that has allowed for transesterification as described herein, e.g., at least one month, specifically at least 3 months, even more specifically 6 months, yet even more specifically at least 1 year, and most specifically at least 2 years.

In one embodiment herein the “low” level of scorch in a polyurethane foam that is made with a flame retardant additive composition that contains a dialkyl phosphite that has been aged at least one month is less than 8 units increase, preferably less than 5 units increase, most preferably less than 3 units increase, and most preferably no change in delta E values of scorch, as compared to a polyurethane foam that is made with an identical flame retardant additive composition (i.e., one containing a dialkyl phosphite) that is unaged.

In one embodiment herein, the use of dialkyl phosphite in the flame retardant additive composition described herein provides for a flame retardant additive composition that is stable for a longer period of time than an equivalent flame retardant additive composition containing other than an dialkyl phosphite, e.g., a flame retardant additive composition that instead employed a triester phosphite. Such improved periods of stability can be limitless in that the use of a dialkyl phosphite does not cause any level of side reaction. Preferably, such improved periods of stability can be greater than about 2-fold, preferably greater than about 10-fold, and most preferably greater than about 25-fold.

In one embodiment the term “stable” as described herein can be understood to mean wherein the amount of dialkyl phosphite (in the embodiments of the invention) or other than dialkyl phosphite (e.g. triester phosphite in the comparative), present in the flame retardant additive composition is greater than about 80 weight % of its original amount in the flame retardant composition, preferably greater than about 90 weight % of its original amount, even more preferably greater than about 95 weight % of its original amount and most preferably greater than about 99% of its original amount. In one embodiment stable is defined as wherein the amount of phosphite present in the flame retardant additive composition is its original amount.

In one embodiment herein the flame retardant additive composition can be stable for a period of at least 3 months, preferably at least 6 months, more preferably at least 12 months and most preferably more than two years.

In one nonlimiting embodiment herein, the flame retardant additive composition(s), the polyurethane foam forming composition, and polyurethane foams made therefrom can be used in any application for which polyurethane foam, e.g., flexible polyurethane foam can be used, such as the nonlimiting applications of upholstery, seat cushions, furniture padding, automotive applications such as automotive seat cushions and the like.

### EXAMPLES

Several test methods are currently available for evaluating the relative performance of stabilizers in polyurethane foam formulations on laboratory scale. Two of the most commonly used methods utilize either dry-oven aging conditions or microwave-oven conditions. In one embodiment herein the method of determining scorch can be any of those described in Andrews, Stephen M.; Revolutionary New Stabilization Technology For Polyurethanes; 60 Years of Polyurethanes; edited by Kresta, Jiri E., et al.; Technomic Publishing Co. Inc., Lancaster-Basel, 1998; pp 101-118 and the Appendix: Antioxidant Properties; U.S. Pat. No. 4,131,660; Reale, Micahel J. et al.; A Rapid Protective Test for Urethane Foam Scorch, Stauffer Chemical Company, Dobbs Ferry, N.Y., reprinted from Journal of Cellular Plastics, Volume 14 September/October 1978, pp 273-276; and, Pernice, R. et al., Scorching of PUR Flexible Foams—A New Lab Test to Evaluate the Performance of Stabilizing Additive, Montedipe S.p.A., Research and Development Center, P. Marghera, Venice, Italy, Journal of Cellular Plastics Volume 24-November, 1988, pp 589-600; each of which are incorporated herein in their entireties. Historically the microwave oven test method was preferred because it was thought to be more representative of the exothermic conditions associated with a full scale foam bun. However given the multitude of variables that affect the repeatability of this methodology, e.g. type of microwave heating (low power settings are achieved by either inverter technology supplying a constant level of heat or by cycling the full power of the magnetron on/off to achieve a similar affect), starting temperature of the microwave cavity for foams made in a series, relative humidity, ambient temperature, etc., dry-oven aging methodologies have become more favored over time.

The work presented below was completed using a dry-oven aging method developed by ICL Supresta Inc., as described below.

### Experimental Details

### Foam Preparation:

For best results, foam prepared specifically for scorch evaluation was used; additionally it was always recommended to prepare and evaluate a foam that has no flame retardant additive as a reference. Foam samples did not have any unnecessary heat history, e.g. exposure to overhead heating lamps after pouring. Sample foams were made in a 8″×8″×4″ cakebox using a 1.0 lb/ft³ formulation with FR added at the typical California TB 117 passing level. An example polyurethane foam formulation is given below:

| | ADDITION LEVEL |
|---|---|
| COMPONENT | (in grams) |
| Vorinol 3136 (polyether polyol with an OH number | 150.0 |
| of 54, available from Dow) | |
| FR (flame retardant available from | variable |
| ICL-IP) | |
| H₂O | 8.40 |
| Methylene Chloride | 15.0 |
| D33LV/A-1 = 3/1 ratio (Dabco BLV catalyst | 0.35 |
| available from Air Products) | |
| Silicone L-620 (Niax Silicone L-620 available from | 1.50 |
| Momentive) | |
| Stannous Octoate T-10 (Dabco T-10 available from | 0.68 |
| Air Products) | |
| TDI (Mondur TD-80 Grade A available from Bayer | 106.7 |
| Material Science) (toluene diisocyanate) | |
| TDI Index | 110 |

All ingredients (polyol, FR, water, silicone and amine) except the tin catalyst and isocyanate were pre-weighed into an appropriate mixing container. The tin catalyst was added to the rest of the ingredients, then mixed with a high speed mixer for 30 seconds, after which TDI was added and the mixing continued for an additional 10 seconds. The mixture was then poured into a cakebox and the foam allowed to rise.

Both the cream and rise times were observed and recorded to ensure foam quality. No artificial heat (e.g., overhead heating lamps) was applied to the foam while it cooled in the hood. After cooling, the foam was stored in a clean and well ventilated room for 48 hours prior to cutting.

### Scorch Evaluation:

In order to prepare foam samples for oven scorch evaluation, the cakebox foam sample was first cut vertically in half, and then a 15 mm thick slice from each half was cut. Four 15 mm×15 mm×2 inch long bars were cut from the center of each piece, in order to obtain a total of eight foam samples taken from the center of the foam bun.

Each 2 inch foam piece was placed in a 25 mm screw top glass vial, then covered with a heat resistant cap/cover. Test tubes were then placed in a preheated aluminum block in a convection flow oven. The foams samples were aged for the desired amount of time and the desired temperature, i.e., between 60 and 180 minutes at 180° C. After reaching the desired time, each sample was removed from the aluminum block and allowed to cool prior to arranging them for color measurement.

For reference, a color standard (lab values L=90; a=0; b=3) was placed in the middle of the foam series prior to taking pictures. After adjusting the white balance and exposure of the camera to get a reading for the color standard that is close to the factory numbers for that standard, a picture of the foams was taken. The picture was then downloaded in jpg format with Photoshop CS4 software. After opening the file with the Photoshop CS4 program and switching the “Mode” to “Lab Color”, the selection tool was used to outline a 1 cm² area in the center of each foam sample. After using the “Blur/Average” tool on the “Filter” tab to even out the color in the outlined sections of each foam sample, the “L”, “a” and “b” values were measured for both the color standard and individual foam samples. The “L”, “a” and “b” values were then used in the following equation

Delta E=\sqrt{(L₁−L₂)²+(a₁−a₂)²+(b₁−b₂)²}

to calculate delta E values from the color standard for all the foam samples. The delta E values are then plotted versus time in order to get a good understanding of the scorch propensity of each foam formulation. L₁, a₁ and b₁ represent measured values for the color standard and L₂, a₂ and b₂ represent measured values for an aged foam sample.

### Foam Evaluation Examples:

### Scorch Graph #1—Reference Commercial Products

Comparative
Fyrol FR-2 is tris(1,3-dichloroisopropyl) phosphate
Fyrol FR-7 is a proprietary chlorinated phosphate ester blend
Fyrol HF-4 is a proprietary non-halogen phosphorus ester

Scorch Graph #2—tribromoneopentyl alcohol/butylated triphenyl phosphate esters (the butylated triphenyl phosphate esters are available as Phosflex 71B from ICL Supresta Inc.) with/without bis(2-ethylhexyl) phosphite (2-EHP) as the stabilizer

Scorch Graph #3—tribromoneopentyl alcohol/butylated triphenyl phosphate esters (the butylated triphenyl phosphate esters are available as Phosflex 71B from ICL Supresta Inc.) with 2-EHP before and after aging (storage @ 70° C. for 1 week to simulate ˜1 year at ambient storage conditions)

### Comparative Example:

Scorch Graph #4—tribromoneopentyl alcohol/butylated triphenyl phosphate esters (the butylated triphenyl phosphate esters are available as Phosflex 71B from ICL Supresta Inc.) with diisodecyl phenyl phosphite (DDPP) before and after aging (storage @ 70° C. for 1 week to simulate ˜1 year at ambient storage conditions)

### Conclusions:

Graph #1 above has been included as a reference showing the relative performance of three commercially available flame retardants products that range from a very high scorch propensity (Fyrol FR-2) to a very low scorch propensity (Fyrol HF-4). The graphical information provided not only gives an indication of the relative scorch propensity of each product, but it also provides insight into how the products perform as the heat insult to the foam increases over time.

Graph #2 illustrates the relative performance of the stabilized and unstabilized blend of tribromoneopentyl alcohol when 2-EHP is used as the stabilizer. The 2-EHP stabilizer is very effective in reducing the scorch of the tribromoneopentyl alcohol blend.

Graphs #3 & #4 illustrate the very good storage stability of the tribromoneopentyl alcohol stabilized with 2-EHP versus the very poor storage stability of the blend stabilized with the alternative phosphite DDPP (Comparative Example). After 1 week under accelerated storage conditions, the product stabilized with DDPP has returned to the performance of the unstabilized blend.

While the process of the invention has been described with reference to certain embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out the process of the invention but that the invention will include all embodiments falling within the scope of the appended claims.

1. A flame-retardant additive composition consisting essentially of:
(a) a halogenated hydroxyl-containing compound; and,
(b) a dialkyl phosphite.

2. The flame retardant additive composition of claim 1 wherein the halogenated hydroxyl-containing compound is a brominated compound.

3. (canceled)

4. The flame retardant additive composition of claim 1 wherein the halogenated hydroxyl-containing compound is solvated in a phosphorus(V) ester.

5. (canceled)

6. The flame retardant additive composition of claim 1 wherein the halogenated hydroxyl-containing compound is selected from the group consisting of tribromoneopentyl alcohol, dibromoneopentyl glycol, Ixol M125, Ixol B251 and combinations thereof.

7. The flame retardant additive composition of claim 1 wherein the dialkyl phosphite is of the general formula (I):
P(=O)(OR)₂H (I)
wherein R is an alkyl group each containing from 1 to about 20 carbon atoms, or the two R alkyl groups are covalently bonded to each other to form a ring structure with the phosphorous atom.

8. (canceled)

9. A polyurethane foam-forming composition comprising a polyol, an isocyanate, a blowing agent, and the flame-retardant additive composition of claim 1.

10-11. (canceled)

12. A polyurethane foam comprising the flame retardant additive composition of claim 1.

13. A polyurethane foam-forming composition comprising (i) a polyol, (ii) an isocyanate, (iii) a blowing agent, and (iv) a flame retardant additive composition comprising:
(a) a halogenated hydroxyl-containing compound; and,
(b) a dialkyl phosphite.

14. (canceled)

15. The polyurethane foam-forming composition of claim 13 wherein the halogenated hydroxyl-containing compound is a brominated compound.

16. (canceled)

17. The polyurethane foam-forming composition of claim 13 wherein the halogenated hydroxyl-containing compound is solvated in a phosphorus(V) ester.

18. (canceled)

19. The polyurethane foam-forming composition of claim 13 wherein the halogenated hydroxyl-containing compound is selected from the group consisting of tribromoneopentyl alcohol, dibromoneopentyl glycol, Ixol M125, Ixol B251, and combinations thereof.

20. The polyurethane foam-forming composition of claim 13 wherein the dialkyl phosphite is of the general formula (I):
P(=O)(OR)₂H (I)
wherein R is an alkyl group each containing from 1 to about 20 carbon atoms or the two R alkyl groups are covalently bonded to each other to form a ring structure with the phosphorous atom.

21. (canceled)

22. The polyurethane foam-forming composition of claim 13 further comprising at least one phosphorus(V) ester.

23. (canceled)

24. A polyurethane foam made by reacting the polyurethane foam-forming composition of claim 13.

25. (canceled)

26. A flame retardant additive composition comprising
(a) a halogenated hydroxyl-containing compound;
(b) a phosphorus(V) ester; and,
(c) a dialkyl phosphite.

27. The flame retardant additive composition of claim 26 comprising
(a) tribromoneopentyl alcohol;
(b) butylated triphenyl phosphate ester; and,
(c) bis(2-ethylhexyl) phosphite.

28. (canceled)

29. A polyurethane foam comprising the flame retardant additive composition of claim 26, which polyurethane foam has a level of scorch that is lower than an equivalent polyurethane foam containing a phosphite other than a dialkyl phosphite, wherein the other than dialkyl phosphite has been aged for at least 6 months.

30. The flame retardant additive composition of claim 1 wherein the composition is stable for a longer period of time than an equivalent flame retardant additive composition containing a phosphite other than a dialkyl phosphite.

31. The flame retardant additive composition of claim 26 wherein the composition is stable for a longer period of time than an equivalent flame retardant additive composition containing a phosphite other than a dialkyl phosphite.

32-33. (canceled)

34. A method of making polyurethane foam comprising:
combining a polyol, an isocyanate, a blowing agent, and a flame retardant additive composition comprising
(a) a halogenated hydroxyl-containing compound; and,
(b) a dialkyl phosphite.

35-38. (canceled)
